(19) United States
(12) Patent Application Publication
(10) Pub. No.: US 2023/0011448 A1
(43) Pub. Date: Jan. 12, 2023

(54) MOBILE EQUIPMENT PRODUCING A CONNECTION QUALITY MAPPING

(71) Applicant: SAGEMCOM BROADBAND SAS, RUEIL MALMAISON (FR)

(72) Inventors: Pierre SABATIER, RUEIL MALMAISON (FR); Patrick BERTHELE, RUEIL MALMAISON (FR)

(21) Appl. No.: 17/784,893

(22) PCT Filed: Oct. 14, 2020
(86) PCT No.: PCT/EP2020/078833

§ 371 Date: Jun. 13, 2022

(30) Foreign Application Priority Data
Dec. 11, 2019 (FR) FR1914181

(51) Int. Cl. G01S 5/00; H04L 5/00

(52) U.S. Cl. CPC G01S 5/0036; H04L 5/0051

(57) ABSTRACT

Mobile equipment including a geo-localization device arranged to determine a current position for the mobile equipment in a space to be mapped; a communication device arranged to communicate with access points of a local network implemented in the space to be mapped; a control component arranged: to control each access point selectively and in independent manner via the communication device so as to cause said access point to transmit a reference signal; to use the reference signals received by the communication device to evaluate respective qualities for the connections between each of the access points and the mobile equipment in the current position.

### BACKGROUND OF THE INVENTION

A distributed Wi-Fi system makes it possible to implement a meshed local network that presents extended coverage.

Such a distributed Wi-Fi system has a plurality of nodes that communicate with one another via a so-called “backhaul” connection, e.g. using a Wi-Fi wireless link or an Ethernet wired link.

The backhaul connection enables the nodes to exchange commands, in particular management commands, via a communication bus. The backhaul connection also serves as a medium for various data streams between the nodes and the network.

Each of the nodes incorporates at least one “fronthaul” Wi-Fi access point to enable external equipment to communicate with the network.

One of the nodes of the distributed Wi-Fi system performs a so-called “master” function. The master node acts to manage the distributed Wi-Fi system, in particular to manage its architecture, and to force each piece of external equipment that is connected to the local network to communicate with one of the fronthaul access points of one of the nodes as a function of local Wi-Fi signal propagation characteristics.

The positions of the nodes and the transmission characteristics of the Wi-Fi signals are not always defined in optimum manner relative to the space that the network is to cover. In particular, if the access points are positioned arbitrarily in a residence by a novice user, then the coverage of the network is not optimized.

### Object of the Invention

An object of the invention is to optimize the coverage of a local network that has a plurality of access points.

### SUMMARY OF THE INVENTION

In order to achieve this object, there is provided mobile equipment comprising:
a geo-localization device arranged to determine a current position for the mobile equipment in a space to be mapped;
a communication device arranged to communicate with access points of a local network implemented in the space to be mapped;
a control component arranged:
   to control each access point selectively and in independent manner via the communication device so as to cause said access point to transmit a reference signal;
   to use the reference signals received by the communication device to evaluate respective qualities for the connections between each of the access points and the mobile equipment in the current position.

The mobile equipment can thus control each access point individually and in succession so that said access point transmits a reference signal. The mobile equipment acquires the reference signals transmitted by all of the access points, and evaluates connection quality in its current position. By moving the mobile element about in the space to be mapped, it is possible to quantify the propagation of the radio signals produced individually by the access points, and to obtain a complete and accurate map of connection quality. The map can be used for configuring the access points of the network so that the space to be mapped is covered as effectively as possible.

There is also provided mobile equipment as described above, wherein the geo-localization device is arranged to perform a method of measuring time-of-flight.

There is also provided mobile equipment as described above, wherein the method of measuring time-of-flight makes use of ultra-wideband (UWB) technology.

There is also provided mobile equipment as described above, the geo-localization device comprising a UWB communication component and a UWB antenna arranged to cooperate with UWB anchors situated in the access points.

There is also provided mobile equipment as described above, wherein connection quality is evaluated from a power level and/or from a binary data rate for each reference signal received by the communication device.

There is also provided mobile equipment as described above, wherein the space to be mapped is partitioned into unit zones of the space, and wherein the control component is arranged to associate the current position and the connection quality as evaluated in the current position with a unit zone of the space in which the current position is situated.

There is also provided mobile equipment as described above, wherein each unit zone of the space is a unit volume.

There is also provided mobile equipment as described above, wherein the control component is arranged to control the power with which each access point transmits the reference signal.

There is also provided mobile equipment as described above, wherein the control component is arranged to select a communication channel over which each access point transmits the reference signal.

There is also provided mobile equipment as described above, wherein the control component is arranged to evaluate, for each access point, a strength for the signal transmitted by said access point and received by the communication device, and to cause each of the access points to transmit reference signals in succession in an order corresponding to decreasing signal strength.

There is also provided mobile equipment as described above, wherein the control component is also arranged to interrogate each access point so that each access point sends to the mobile equipment a power level for the signal received by said access point.

There is also provided mobile equipment as described above, wherein the control component is also arranged to interrogate each access point so that said access point sends to the mobile equipment functional characteristics of said access point.

There is also provided mobile equipment as described above, the mobile equipment being a smartphone.

There is also provided a mapping method for mapping a space to be mapped, the method comprising the steps of:
acquiring the current position of the above-described mobile equipment;
controlling each access point selectively and in independent manner via the communication device so as to cause said access point to transmit a reference signal;
for each access point, evaluating a quality for the connection between said access point and the mobile equipment in the current position;
creating a current record containing the connection qualities associated with the current position;
storing the current record in a database. There is also provided a mapping method as described above, wherein the space to be mapped is partitioned into a plurality of unit zones of the space, the mapping method further comprising the step of defining a current unit zone of the space in which the current position is situated, and of associating the current record with the current unit zone of the space.

There is also provided a mapping method as described above, wherein, for each access point, connection qualities are evaluated for a plurality of transmission configurations of said access point.

There is also provided a mapping method as described above, wherein the database also includes functional characteristics of the access points.

There is also provided a mapping method as described above, wherein the database also includes timestamped positioning data for the mobile equipment.

There is also provided a mapping method as described above, further comprising the step of producing a map showing the zones that have been covered and the zones that have not yet been covered by the method for mapping the space to be mapped.

There is also provided a computer program including instructions for causing the above-described mobile equipment to execute the steps of the above-described mapping method.

There is also provided a computer-readable storage medium, having recorded thereon the above computer program.

The invention can be better understood in the light of the following description of a particular, nonlimiting implementation of the invention.

### BRIEF DESCRIPTION OF THE DRAWINGS

Reference is made to the accompanying drawings, in which:

FIG. 1 is a diagram showing a piece of mobile equipment of the invention and access points;

FIG. 2 shows an example map;

FIG. 3 shows a smartphone of the invention;

FIG. 4 shows an access point;

FIG. 5 shows how UWB geo-localization is performed;

FIG. 6 shows steps in a selection method enabling the smartphone to select an access point;

FIG. 7 shows steps in a collection method enabling the smartphone to collect functional characteristics of an access point;

FIG. 8 shows unit volumes of a partitioned space to be mapped;

FIG. 9 shows steps of a scanning method enabling the smart phone to scan the transmission configurations of the access points;

FIG. 10 shows steps of a method of managing records;

FIG. 11 shows a map obtained by the mapping method.

### DETAILED DESCRIPTION OF THE INVENTION

A distributed Wi-Fi system having a plurality of access points for providing a local network is installed in a residence.

An object of the invention is to map, within the residence, the quality of connections with the various different access points.

With reference to FIG. 1, this is done by using a piece of mobile equipment 1 that comprises a geo-localization device 2, a communication device 3, and a control component 4.

The mobile equipment 1 is moved either by user or else automatically.

At regular intervals, the geo-localization device 2 of the mobile equipment 1 determines the current position of the mobile equipment 1 within the residence.

The communication device 3 is arranged to communicate with the access points 5.

The control component 4 controls each access point 5 selectively and in independent manner via the communication device 3 so as to cause each said access point 5 to transmit a reference signal. The communication device 3 receives the reference signals. On the basis of the reference signals received by the communication device 3, the control component 4 evaluates quality values for the connections between each of the access points 5 and the mobile equipment 1 in the current position.

By moving the mobile equipment 1 throughout the residence, a map is obtained of connection quality with the access points 5.

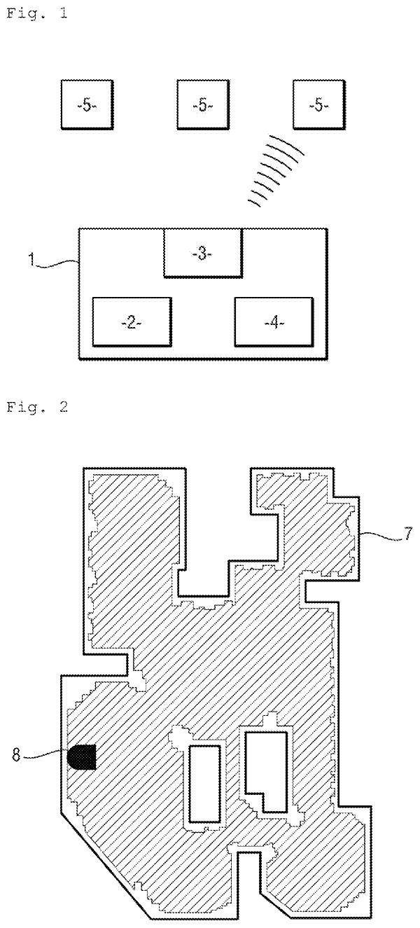

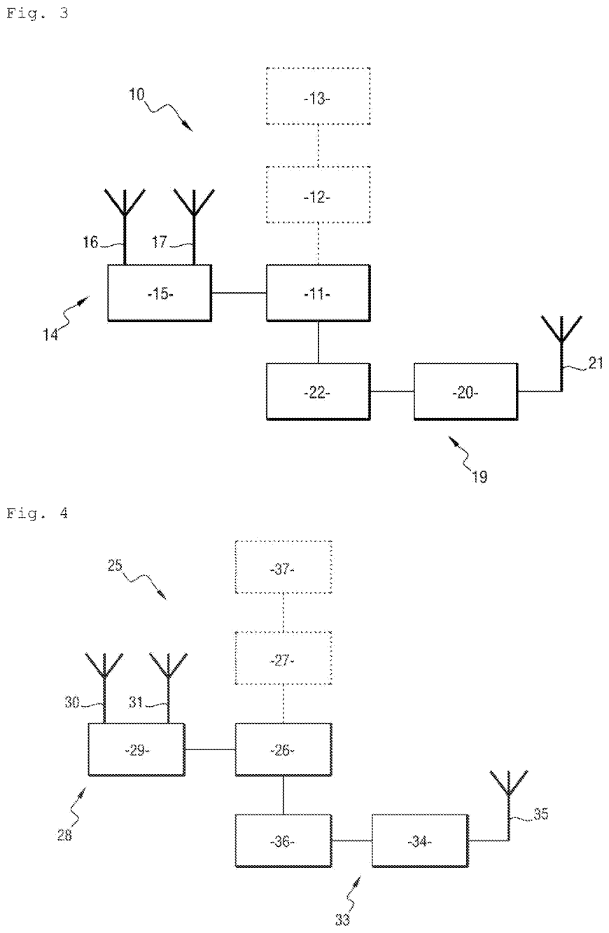

By way of example, this map may be similar to the map of FIG. 2, which is a two-dimensional map made in a residence 7 using mobile equipment 8.

By way of example, the mobile equipment that is used may be a smartphone.

With reference to FIG. 3, the smartphone 10 includes firstly a control component. The control component is a central processor 11 that is controlled by an operating system 12.

The central processor 11 is adapted to execute instructions of an application 13 for performing the mapping method as described below.

The smartphone 10 also has a communication device, which is a (native) Wi-Fi communication interface 14 comprising a Wi-Fi communication component 15, a first antenna 16, and a second antenna 17. The Wi-Fi communication component 15 has a 2.4 gigahertz (GHz) channel connected to the first antenna 16 and a 5 GHz channel connected to the second antenna 17.

The central processor 11 controls the access points via the Wi-Fi communication interface 14 so as to cause them to transmit Wi-Fi reference signals. The Wi-Fi communication interface 14 acquires the Wi-Fi reference signals transmitted by the access points. The central processor 11 evaluates the connection qualities of the Wi-Fi reference signals received by the Wi-Fi communication interface 14.

The smartphone 10 also has a geo-localization device 19. The geo-localization device 19 is arranged to perform a method of measuring time-of-flight. In this example, the method of measuring time-of-flight makes use of ultra-wideband (UWB) technology.

In this example, the geo-localization device 19 natively forms a part of the smartphone 10. The geo-localization device 19 comprises a communication component 20, an antenna 21, and a microcontroller 22. The microcontroller 22 is connected to the central processor 11 via a wired interface (e.g. an inter-integrated circuit (I2C) interface, a serial interface, etc.) or a wireless interface (e.g. Bluetooth).

Alternatively, the geo-localization device could comprise a UWB tag. The UWB tag would then be positioned as close as possible to the smartphone, or indeed could be incorporated in the smartphone.

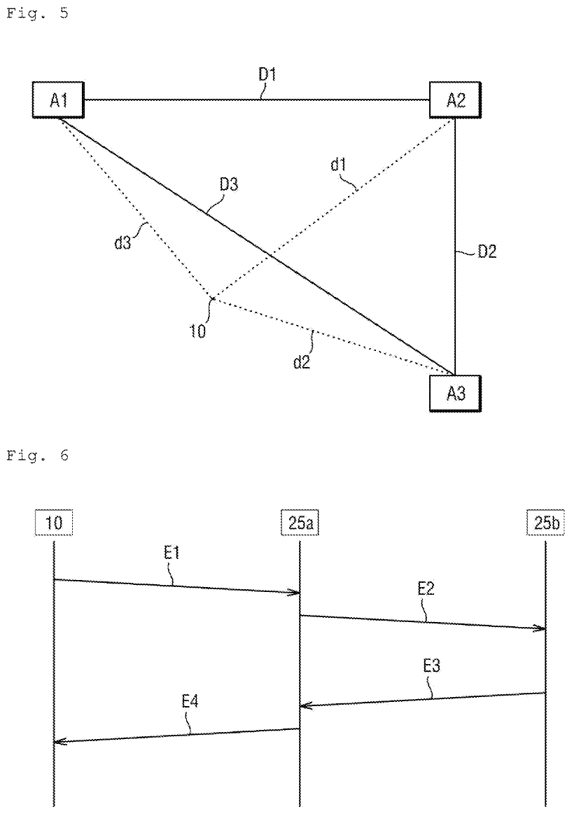

With reference to FIG. 4, each access point 25 includes a central processor 26 that is controlled by an operating system 27.

The access point 25 also includes a Wi-Fi communication interface 28 comprising a Wi-Fi communication component 29, a first antenna 30, and a second antenna 31. The Wi-Fi communication component 29 has a 2.4 GHz channel connected to the first antenna 30 and a 5 GHz channel connected to the second antenna 31.

The access point 25 also has a geo-localization device 33. The geo-localization device 33 comprises a UWB communication component 34, a UWB antenna 35, and a microcontroller 36. The microcontroller 36 is connected to the central processor 26 via a serial connection. The microcontroller 36 dialogues with the UWB communication component 34 and supplies the central processor 26 with localization information. The operating system 27 serves to manage this localization information.

The central processor 26 is adapted to execute instructions of software 37 in order to perform geo-localization of the smartphone 10.

The operating system 27 makes the positioning information available, e.g. via a software interface or an application programming interface (API). The positioning information is recovered and then processed by an application.

At the time of its installation, each access point 25 is registered with a unique number, e.g. its media access control (MAC) address.

How geo-localization is performed is described in greater detail below.

As mentioned above, the geo-localization is UWB geo-localization.

The geo-localization devices 33 of the access points 25 form UWB anchors.

In this example, it can thus be seen that the UWB anchors are incorporated in the access points 25. This is not essential, the UWB anchors could perfectly well be distinct from the access points 25, and in particular they could be positioned at different locations.

The geo-localization is based on trilateration performed on the basis of distance measurements between various different elements.

The distances between the elements taken in pairs are obtained by measuring the time-of-flight of wideband pulse RF signals that have the property of travelling in straight lines and of passing through obstacles that are encountered in the environment of a residence, or more generally in any building.

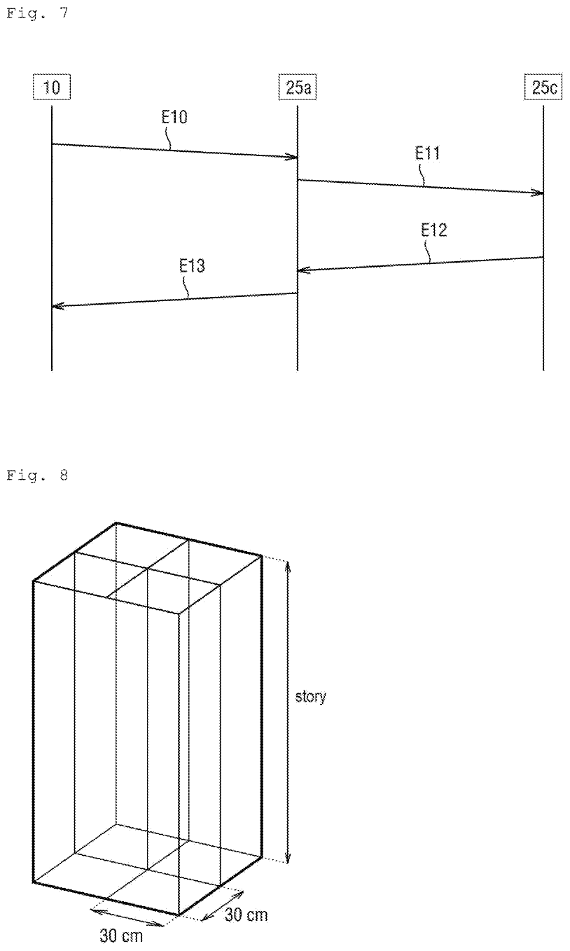

With reference to FIG. 5, and using an established network of fixed points (the UWB anchors A1, A2, and A3) forming a reference frame, with relative positions that are evaluated by the system from the distances between the fixed points (distances D1, D2, & D3), the absolute position of the smartphone 10 relative to the reference frame is localized accurately.

The position of the smartphone 10 is to be found at the point of intersection between spheres centered on each of the UWB anchors. The radius of a sphere centered on a UWB anchor corresponds to the distance between the smartphone 10 and said anchor UWB, and it is calculated from the time-of-flight of the UWB signal.

In this example, with a network of three anchors, estimated distances are calculated for the smartphone 10 relative to the various anchors, i.e. d1, d2, and d3.

The acquisition of geo-localization data is illustrated below using a particular example of selected components.

By way of example, use is made of the DECAWAVE MDEK1001 localization solution. The UWB communication component 20 of the smartphone 10 is a DECAWAVE DW1000 component. The microcontroller 22 of the smartphone 10 is a NORDIC microcontroller containing DECAWAVE firmware enabling the UWB communication component 20 to be used. The two components communicate with each other via a serial connection.

The UWB communication component is in charge of forming and transmitting the radiofrequency (RF) pulse signals defined by the NORDIC microcontroller, and of receiving and decoding the received RF pulses in order to extract useful data therefrom and transmit that data to the NORDIC microcontroller.

The NORDIC microcontroller is in charge of configuring and using the UWB communication component in order to generate bursts, and of decoding the returned bursts, thereby making it possible from the go and return times-of-flight to calculate the distances between the pieces of equipment. The microcontroller can thus obtain directly the distances between the UWB communication component and the other pieces of equipment, and from the other pieces of equipment it can also obtain additional information concerning the respective distances between those other pieces of equipment. Knowing these various different distances, the microcontroller is in charge of evaluating the geographical position of each piece of equipment relative to a network of reference anchors. To do this, it performs a trilateration method.

The NORDIC microcontroller is also in charge of communicating with the central processor 11 of the smartphone 10 through a serial port connected via a universal serial bus (USB) connection, or directly via a serial connection, or indeed via a Bluetooth connection. It can thus receive commands to undertake specific actions, and to transmit responses to the central processor 11.

The NORDIC microcontroller provides a certain number of commands for triggering a certain number of actions, and for obtaining a certain number of actions in return. It is also possible to add commands to those that already exist, since the development environment is open and the source code is fully documented.

In its default mode of operation, the NORDIC microcontroller sends reports periodically over the serial connection carried by the USB link, these reports concerning the state of the system and being in the form of character strings. An example character string corresponding to localization is as follows:
{‘timestamp’: 1569763879.354127, ‘x’: 2.168, ‘y’: 0.62844, ‘type’: ‘tag’};
{‘timestamp’: 1569763879.937741, ‘type’: ‘anchor’, ‘x’: 0.0, ‘y’: 0.0};
{‘timestamp’: 1569763879.9407377, ‘type’: ‘anchor’, ‘dist’: 3.287105, ‘x’: 3.5, ‘y’: 0.0};
{‘timestamp’: 1569763879.943739, ‘type’: ‘anchor’, ‘dist’: 9.489347, ‘x’: 3.5, ‘y’: 9.0}.

This data is easily broken down. Each line corresponds to one of the pieces of equipment of the system (access point 25 or smartphone 10), and it is easy to identify the following fields and their associated values:
timestamp: time the report was sent by the geo-localization device of the smartphone 10;
x and y: coordinates (expressed in meters) of the piece of equipment relative to the reference frame formed by the anchors. The coordinates of the anchors are returned with accuracy rounded to within 0.5 m;
type: type of the equipment: tag=smartphone, anchor=UWB anchor;
dist: distance in meters between the smartphone 10 and the UWB anchor that is the reference point of the system. This information does not exist for the reference anchor.

In this example, there are thus four pieces of equipment.

The smartphone 10 is situated at the coordinates x=2.168 m, y=0.628 m.

The reference anchor is situated at the coordinates x=0 m, y=0 m.

Another anchor is situated at the coordinates x=3.5 m, y=0 m, at a distance of 3.287 m from the reference anchor.

Yet another anchor is situated at the coordinates x=3.5 m, y=9.0 m, at a distance of 9.489 m from the reference anchor.

This information is supplied via the USB connection to the operating system 12 of the central processor 11 of the smartphone 10. It is easy for the software embedded in the central processor 11 to collect this information and to process it.

The above example shows geo-localization in a plane. It is also possible to obtain geo-localization in three-dimensional space providing there are at least four anchors deployed in three dimensions and not all in a single plane.

There follows a description of how the control component of the smartphone 10, i.e. central processor 11, controls the access points.

As mentioned above, the Wi-Fi interface 14 acquires the reference signals transmitted by the access point 25, thereby making it possible to evaluate connection quality between each access point 25 and the smartphone 10 in its current position.

Nevertheless, in its normal mode of operation, the smartphone 10 is by default in communication with the best access point 25 as selected by the distributed Wi-Fi system. For example, radio quality measurements do not make it possible to characterize the real coverage of a particular access point.

The central processor 11 of the smartphone 10 thus communicates with the access points 25 and controls them selectively and independently so that the access points 25 transmit the reference Wi-Fi signal in turns.

With reference to FIG. 6, and for this purpose, the smartphone 10 sends an access point selection message to the master access point 25a (step E1), e.g. via the backhaul connection bus conveyed by the Wi-Fi connection with the current access point and relayed by the backhaul.

The master access point 25a then implements its mechanisms for active management of the access points in order to activate the selected access point 25b (step E2), e.g. by performing “whitelist/blacklist” management, or by forcing an access point jump, or by using any other method available to it. The selected access point 25b sends an acknowledgement message to the master access point 25a (step E3), which relays it to the smartphone 10 (step E4).

In this example, and in nonlimiting manner, the smartphone 10 selects access points in the following manner.

For each access point, the central processor 11 of the smartphone 10 evaluates the strength of the signal transmitted by said access point and received by the communication device of the smartphone 10, and causes each of the access points and 25 to transmit reference signals in succession in an order corresponding to decreasing signal strength.

Specifically, the application 13 of the smartphone 10 is connected by default to the best access point as defined by the master access point using a conventional roaming method.

Once a measurement has been taken with the best access point, the central processor 11 requests to switch to the second best access point as specified by the master access point, and so on to the last accessible access point.

The central processor 11 and the smartphone 10 can thus define the characteristics of the Wi-Fi reference signals.

By way of example, the central processor 11 may define the power with which each access point 25 transmits the reference Wi-Fi signal. It is thus possible to cause a particular access point 25 to transmit a beacon signal by using a specific power that is different from its natural power, e.g. 6 decibels (dB) lower.

A specific command is then sent to the master access point by the smartphone 10 via the backhaul connection. This command is interpreted by the access point under consideration and then translated into a low level command that is sent to the radio interface. For example, the command:
w1 pwr_percent 50
   instructs the access point to reduce its transmission power by 6 dB.

This feature enables the smartphone 10, when in a given location, to take different reception power measurements, and thus to refine a measurement for which a normal power signal received from the access point might be saturated as a result of its proximity.

The central processor 11 is also arranged to select a communication channel over which each access point 25 transmits the reference Wi-Fi signal. It is thus possible to envisage causing a particular access point to make use of a transmission channel other than the channel for which it was originally configured.

A specific command is then sent to the master access point by the smartphone 10 via the backhaul connection. This command is interpreted by the access point under consideration and then translated into a low level command that is sent to the radio interface. For example, the command:
iwconfig channel 6
   instructs the access point, which is of Qualcomm type, to select channel 6 for communicating. All of these commands could be executed by temporarily forcing the selected access point to make use of the requested characteristics in its normal service set identifier (SSID). They can also be executed by adding a beacon to the access point, which beacon is specific to the requested measurement (e.g. a predefined SSID) that has the requested characteristics (channel, power, etc.), thereby avoiding disturbance to the native operation of the system.

This feature enables the smartphone 10 to take coverage measurements in a given location for different working frequencies.

There follows a description of the manner in which the smartphone evaluates connection quality with the various access points. As mentioned above, for each access point, the central processor 11 evaluates connection quality on the basis of received Wi-Fi reference signals.

Connection quality can be evaluated by measuring one or more parameters: received signal level, e.g. received signal strength indication (RSSI) associated with a transmission channel or frequency, binary data rate, etc.

By way of example, the Wi-Fi communication interface of the smartphone uses the Linux iwconfig command, which returns the received signal level or RSSI together with the frequency (as in the above example).
w1p3s0 IEEE 802.11 ESSID:“boxcom”
Mode:Managed Frequency: 5.5 GHz
Access Point: 2C:39:96:FF:A2:F5
Bit Rate=135 Mb/s Tx-Power=15 dBm
Retry short limit: 7 RTS thr:off Fragment thr:off
Power Management:on
Link Quality=45/70 Signal level=−65 dBm
Rx invalid nwid:0 Rx invalid crypt:0 Rx invalid frag:0
Tx excessive retries:0 Invalid misc:106 Missed beacon:0

In the trace of this Wi-Fi command, there is the Wi-Fi reference signal level at −65 dBm.

This is the indication that is used for establishing the Wi-Fi map.

Other information may be collected (latency time/ping, etc. . . . ) by means of communication set up with the selected access point, e.g. by using an exchange of files with the access point 25 to measure the bidirectional data rate between the smartphone 10 and said access point.

The central processor 11 of the smartphone 10 may also interrogate each access point 25 in such a manner that said access point sends to the smartphone 10 the power level of the Wi-Fi signal that said access point has received.

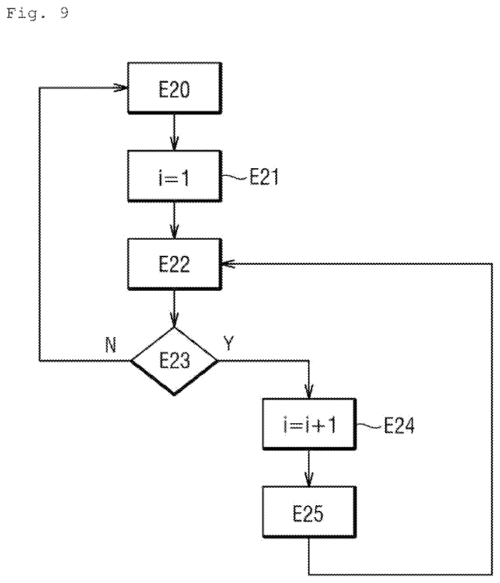

With reference to FIG. 7, a specific command is sent to the master access point 25a by the smartphone 10 via the backhaul connection (step E10). This command is transferred to the interrogated access point 25c via a low level command sent to the Wi-Fi interface of the interrogated access point 25c (step E11). The interrogated access point 25c sends the RSSI to the master access point 25a (step E12), which relays it to the smartphone 10 (step E13).

For example, the command:
w1 rssi 90:4d:4a:cc:6b:8e
   serves to obtain the reception conditions of the interrogated access point having the MAC address:
90: 4d:4a:cc:6b:8e.

It is also possible to collect information relating to the power level of the signal received by a particular access point 25 without establishing communication therewith. For example, under Windows, the command:
netsh wlan show all
   provides a signal reception report for all of the access points in the vicinity, but without that setting up communication with them. The information is derived from the reception of beacon signals transmitted by those access points.

The following example shows the response for an environment having a single access point:
SSID 22: WiFi-2.4-6B90

Network type: Infrastructure

Authentification: WPA2Personal

Encryption: CCMP

BSSID 1: 90:4d:4a:cc:6b:96
Signal: 71%
Radio type: 802.11n
Channel: 6
Basic rates (Mbps): 1 2 5.5 11
Other rates (Mbps) : 6 9 12 18 24 36 48 54

The measurements taken by the smartphone 10 serve to create a database. The database may be stored in the smartphone 10, in one of the access points 25 of the distributed Wi-Fi system, or indeed in a remote server. The database could equally well be distributed among those pieces of equipment, or indeed it could include a buffer zone in the smartphone 10 in order to guarantee rapid access to the records.

The measurement results are thus stored in a first table of this database, referred to as the “measurement table”, which table can be used during post treatment, e.g. in order to perform calculations to optimize access point positions, or to modulate access point powers, or for any other purpose.

The space to be mapped is partitioned into unit zones of the space, which may be unit areas or unit volumes, and which are positioned relative to a reference frame of reference.

The central processor 11 of the smartphone 10 associates the current position and the connection qualities evaluated in the current position with that one of the unit zones of the space in which the current position is situated.

Thus, in the measurement table, each record obtained while the smartphone 10 is in a current position corresponds to a unit zone of the space defined around a point identified by its coordinates.

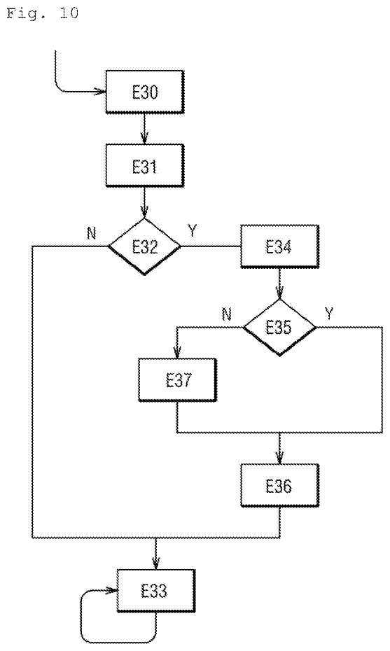

For example, with reference to FIG. 8, a volume of 15 m×15 m, having three stories, each 2.5 m in height, and covering the residence, is subdivided into a set of 50×50×3=7500 rectangular parallelepipeds measuring 0.3 m×0.3 m×2.5 m, each surrounding a point that is spaced apart from its neighboring points by 30 centimeters (cm) in a horizontal plane, and by 2.5 m in a vertical plane. These unit volumes correspond to as many records in the measurement table of the database.

Thus, a record in the measurement table corresponding to the box having its central point situated at the coordinates x=0.0 m, y=0.0 m, z=0.0 m is used to cover all possible positions around this central point and having real coordinates lying in a space of ±15 cm on either side of this central point on the x and y axes, and of ±1.25 m up and down the z axis.

The records in the measurement table of the database are created progressively as the smartphone 10 is moved about, thereby augmenting the mapping data.

By way of example, each record may contain the following fields:
the position of the central point of the unit zone of the space relative to the reference frame, for the current position in which the record was made;
the identity of the current access point allocated to the smartphone by the manager of the distributed Wi-Fi network;
the identity of the access point used for a first measurement, e.g. its MAC address;
   a subfield identifying a channel used by this first access point;
   a subfield identifying the power used by this first access point;
   a subfield containing a value representing an evaluation of the quality of the connection with the first access point on this first channel as a result of using this first power;
   a subfield containing the timestamp of the most recent measurement taken under these conditions;
the identity of the access point used for a second measurement, etc.

An example of the content of the measurement table in the smartphone could be as follows:
0.0, 1.0, 0.0
C4-85-08-B2-36-03
C4-85-08-B2-36-03; 06; 20 dBm; −65 dBm; 2019/10/21
12:53:00.554
C4-85-08-B2-36-05; 01; 14 dBm; −55 dBm; 2019/10/17
06:52:45.35
0.0, 1.3, 0.0
C4-85-08-B2-36-03
C4-85-08-B2-36-03; 06; 20 dBm; −55 dBm; 2019/10/21
12:53:27.002
C4-85-08-B2-36-05; 01; 14 dBm; −65 dBm; 2019/10/17
06:52:45.35

A second table the database contains functional characteristics of the various UWB anchors.

By way of example, the second table may be built up progressively as the smartphone 10 discovers new UWB anchors while it is being moved about in the residence.

In this example, the second table contains a record for each of the UWB anchors of the system, with each record containing, by way of example:
a first field showing the name of the UWB anchor;
a second field showing the x, y, z coordinates of the UWB anchor in the reference frame.

Advantageously, additional information showing the capabilities of the nodes in which the UWB anchors are located is also connected by the central processor 11 of the smartphone 10 by means of specific commands passing via the backhaul. These capabilities are used by the system to specify all possible variants of measurements of radio propagation conditions.
a third field showing a first capability of the access point in which the anchor is incorporated, e.g. the availability of the 2.4 GHz mode;
   a subfield may be used to show the identity of the 2.4 GHz access point, e.g. its MAC address;
   a subfield may be used to show the capacity of the 2.4 GHz mode for managing different channels;
   a subfield may be used to show the capacity of the 2.4 GHz mode for managing different powers;
a fourth field showing a second capability of the Wi-Fi access point, e.g. the availability of the 5 GHz mode;
   a subfield may be used to show the identity of the 5 GHz access point, e.g. its MAC address;
   a subfield may be used to show the capacity of the 5 GHz mode for managing different channels;
   a subfield may be used to show the capacity of the 5 GHz mode for managing different powers.

An example of the content of the second table might be as follows:
Anchor1

x=0.0

y=0.0

z=0.0

AP_2.4_enable=true; “C4-85-08-B2-36-03”; “1, 2, 3, 4, 5, 6, 7, 8, 9, 10, 11, 12, 13”; “20.0, 14.0, 8.0”

AP_5_enable=true; “C4-85-08-B2-37-04”; “36, 40, 44, 48, 52, 56, 60, 64”; “20.0”
Anchor 2

x=3.5

y=0.0

z=0.0

AP_2.4_enable=true; “C4-85-08-B2-36-04”; “1, 2, 3, 4, 5, 6, 7, 8, 9, 10, 11, 12, 13”; “20.0, 14.0, 8.0”

AP_5_enable=true; “C4-85-08-B2-37-05”; “36, 40, 44, 48, 52, 56, 60, 64”; “20.0”
Anchor 3

x=3.5

y=9.0

z=0.0

AP_2.4_enable=true; “C4-85-08-B2-36-05”; “1, 2, 3, 4, 5, 6, 7, 8, 9, 10, 11, 12, 13”; “20.0, 14.0, 8.0”

AP_5_enable=true; “C4-85-08-B2-37-06”; “36, 40, 44, 48, 52, 56, 60, 64”; “20.0, 14.0”

The database also includes a third table. The third table contains information about the movements of the smartphone 10 and it may be used to augment the mapping information, e.g. to reveal a thin obstacle, such as a partition, that has very little influence on radio propagation measurements, and that is too thin to completely prevent access to a complete unit zone of the space.

The path followed by the smartphone 10 could also be used to show that the smartphone 10 has never been moved directly from one unit zone of the space to another zone that is nevertheless adjacent, thereby showing the presence of a potential very small obstacle preventing the smartphone from following such a path.

To do this, the third table may include a sequence of records containing the coordinates of the unit zones of the space that have been passed through together with timestamps for entering or exiting the unit zones of the space.

Implementation of the method of mapping the residence is described below in greater detail.

The smartphone 10, associated with the network of access points 25, executes the software that implements the mapping method.

The application 13 may be started or paused by acting on a button, e.g. in a menu.

Once it is being executed, the application 13 acts at regular intervals, e.g. every second, to collect its position relative to the reference system formed by the UWB anchors.

By making use of the database as described above, the application 13 performs the following operations:
determining in the measurement table the record that corresponds to the present position of the smartphone 10.

To do this, the application calculates the coordinates of the central point of the unit zone of the space corresponding to its position as supplied by the geo-localization device by rounding its own x and y coordinates to the closest multiple corresponding to the granularity of the database. The application selects this record as the current record.

For example, in the chosen example, since the granularity of the database is 0.3 m on the x and y axes, and for the real coordinates of the smartphone being x=2.168 m, y=0.62844 m, it is the database record corresponding to the coordinates x=2.1 m, y=0.6 m that is the record having its central point closest to the real position of the smartphone, and it is therefore this record that is selected as the current record.

If this record does not exist in the database, it is added by using conventional commands for adding a record to a database.
recovering the selected record from the database and extracting therefrom the various fields corresponding to the various measurements.
so long as collecting the position of the smartphone 10 does not end up selecting another record, i.e. so long as the smartphone 10 has not changed its unit zone of the space, it is possible to evaluate various conditions of use of the access points of the distributed Wi-Fi system, and thus augment the current record of the database.

The following sequence may be implemented one or more times:
evaluating connection quality with the current access point.

Thus, in the above example, the smartphone 10 receives from the access point a signal level equal to −65 dBm (Signal level=−65 dBm) coming from the access point 2C:39:96:FF:A2:F5, while it is transmitting a signal on channel 100 (Frequency: 5.5 GHz) with a power of 15 dBm (Tx−Power=15 dBm).

This information is recorded in the database.

Additional information may also be retained, such is the quality of the link (Link Quality=45/70) or indeed the modulation used (Bit Rate=135 Mb/s).
so far as possible, these measurements are augmented depending on the travel speed of the user of the smartphone. In particular, measurements of the signals transmitted by default by the other access points of the system may be collected.

To do this, the mechanisms for measuring other radio conditions (signals received from the other access points, signals as seen by the access point) may be performed, and the results can be added to the current measurements.

In the same manner, the above-described mechanisms for controlling the access points 25 can be applied on the basis of the records in the second table (of anchors) in order to scan each of the channel configurations, radio interface, and power table, thereby augmenting the current measurements by as many values corresponding to the various measurement configurations.

Each measurement corresponding to a particular condition for the access point and the smartphone 10 is considered as being a field of the current record in the measurement table the smartphone 10.

Thus, by making use a posteriori of the measurement table of the smartphone, it is possible to show the propagation conditions of a radio signal for a particular condition of access point, channel, and power.

The map can therefore be considered as being a “multi-layer” map. Each layer corresponds to a measurement condition.

FIG. 9 shows the steps of a method of scanning all of the possible configurations in order to establish measurements corresponding to each of the configurations.

Measurements are initially taken in a default configuration (step E20). The variable i is also initialized to 1 (step E21).
i=1.

Measurements M(i) are taken corresponding to this first configuration. The results are stored in the database (step E22).

It is verified whether another configuration is available (step E23).

If not, the scanning method returns to step E20.

If so, the variable i is incremented by unity: i=i+1 (step E24).

The smartphone 10 configures the access point 25 to force a new measurement configuration (step E25).

The scanning method then returns to step E22.

It should be observed that the various different possible iterations for each measurement corresponding to the same condition may be averaged in order to refine the accuracy of the value.

They could also be averaged by making use of weighting with the previous value restored from the current record in the database. For example, giving a weighting of 4 to the measured average and of 1 to the restored value makes recent measurements more important than the historical value.

In the same manner, restored values having a timestamp exceeding a limit (e.g. values more than 1 month old) could be ignored as being too old.
when collecting the position of the smartphone 10 leads to another record being selected in the database, the measurements corresponding to the location that has just been left are saved in the database using conventional commands for modifying a record in a database.

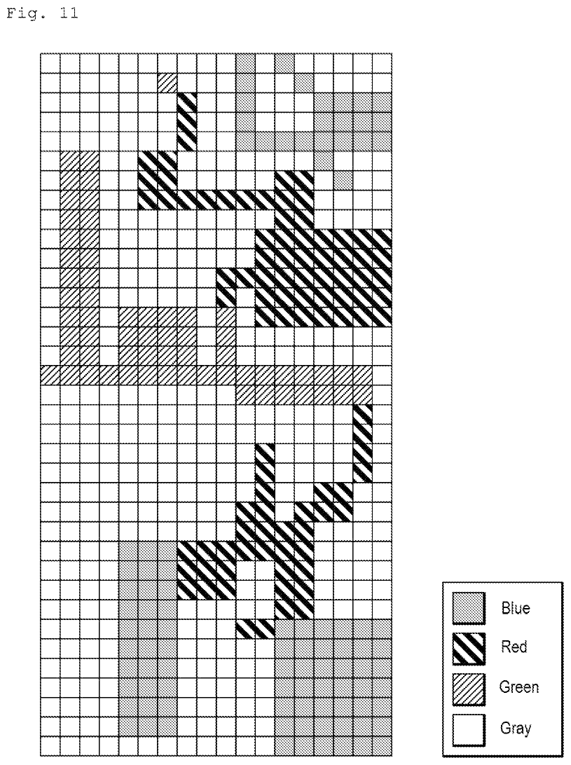

FIG. 10 shows the steps of a method of managing records during travel leading to the smartphone being moved.

The geo-localization device produces the x, y, and z coordinates of the current position of the smartphone (step E30).

The current record is selected in the database (step E31). It is verified whether this is a new current record (i.e. the smartphone has moved into another unit zone of the space): step E32. If not, measurements are taken (step E33).

If so, the measurements of the previous current record are saved (step E34).

It is verified whether the previous current record exists (step E35). If so, the measurements are recovered (step E36). Otherwise, the previous current record is created (step E37), and the measurements are recovered (step E36).

Measurements are then taken (step E33).

As mentioned above, the database also has a third table containing the movements of the smartphone 10. It is then appropriate, simultaneously, to create a new record in the third table. This record contains the localization of the location that has just been left, and the timestamp of that event.

The database is then used to produce a map that can be displayed on the screen of the smartphone 10. In this example, the map performs two functions: showing connection qualities in the mapped space, and providing graphical assistance in acquiring measurements.

The user moving in the meshed space travels more or less quickly through the various unit zones of the space corresponding to the various records in the measurement table of the smartphone. In order to assist the user in completing the mapping as effectively as possible, the user is presented in this example with means for showing graphically the unit zones of the space that have already been covered, thereby revealing the unit zones of the space that have not yet been covered, while also showing the real coverage as revealed during the movement of the user in the form of a color code.

Using a graphics display tool makes it possible to show a grid of unit zones of the space corresponding to the records in the database.

Colored shapes such as squares can be created and shown on the screen. This graphical representation can be extended to three dimensions by using a representation in the form of colored cubes that are more or less transparent.

Since each record in the database corresponds to a square zone having a side of 30 cm positioned in an x, y reference frame, it is natural to represent these zones by as many squares of defined size positioned at coordinates defined to scale so as to show the zone in a screen space, e.g. using a scale of 1 pixel per centimeter. Thus, a zone corresponding to a record in the database could be represented in the form of a square having a side of 30 pixels and positioned at the corresponding coordinates.

In FIG. 11, there can be seen a two-dimensional graphical representation derived by making use of the database.

Reading successively through the records in the measurement table thus gives rise to a plan having as many corresponding squares.

Since the database contains values corresponding to measurements taken under different conditions, the representation may be limited to representing only certain conditions, for example to the single current access point that is allocated by the distributed Wi-Fi network manager to each geographical point.

The representation of the database could be limited to reading and showing only those measurement values that correspond to the selected condition. By way of example, the selection may be made by means of a configuration menu.

The squares corresponding to the records are colored using a color that depends on the value taken from the record.

For example, and with reference to FIG. 11:
green color=measurement>−65 dBm;
red color=measurement>−50 dBm; and
blue color=measurement>−30 dBm.

This representation thus shows a background corresponding to a zone, the path that led to the measurements, and an indication of the quality of the signal.

The portions that are pale gray in color represent zones that were not covered by measurements. The user can thus select to pass through them, or else can recognize them as zones that are inaccessible.

With increasing passes of the user in the zone, its coverage becomes more precise.

Reading the anchor table (the second table in the database) shows the coordinates of each of the UWB anchors of the system. It is thus possible to draw a geometrical shape on the screen for each of the anchors, e.g. a black square having a diameter of a few pixels that is positioned at the location of the anchor using the same cm/pixel scale. In order to improve user understanding, the name of the UWB anchor could be marked on the image in the form of text.

It is also advantageous to show the square corresponding to the user's current position by highlighting or flashing.

Optionally, the map of the zone could be used to associate each square with a name such as “kitchen”, or “living room”, etc. To do this, the graphical interface may be used by way of example in association with cursor management enabling a certain zone of the graphic, or certain boxes, to be selected and to be labelled.

The labels can advantageously be recorded as additional fields in the measurement table of the smartphone 10, or in an independent table describing the space.

This graphical representation tool may be coupled with and executed simultaneously with the method of collecting measurements, or it may be executed independently.

Walls are defined on the map as gaps. A plan is thus obtained of the residence in which its walls and inaccessible zones, such as tall pieces of furniture, appear to be “hollow”.

Naturally, the invention is not limited to the embodiment described, but covers any variant coming within the ambit of the invention as defined by the claims.

The mobile equipment of the invention need not necessarily be a smartphone, but could be any other piece of equipment suitable for being moved (by a user or indeed independently), and for example it may be a tablet, a smartwatch, a vacuum cleaner, etc.

The geo-localization performed by the mobile equipment need not necessarily be UWB geo-localization. For example, it would be possible to use indoor acoustic geo-localization relying on the propagation of sound waves. The principle is identical, except that propagation speeds differ by several orders of magnitude, the speed of light is about 300,000 kilometers per second (km/s), while the speed of sound is of the order of 300 meters per second (m/s).

1. Mobile equipment comprising:
a geo-localization device arranged to determine a current position for the mobile equipment in a space to be mapped;
a communication device arranged to communicate with access points of a local network implemented in the space to be mapped;
a control component arranged:
to control each access point selectively and in independent manner via the communication device so as to cause said access point to transmit a reference signal;
to use the reference signals received by the communication device to evaluate respective qualities for the connections between each of the access points and the mobile equipment in the current position.

2. The mobile equipment according to claim 1, wherein the geo-localization device is arranged to perform a method of measuring time-of-flight.

3. The mobile equipment according to claim 2, wherein the method of measuring time-of-flight makes use of ultra-wideband (UWB) technology.

4. The mobile equipment according to claim 3, the geo-localization device comprising a UWB communication component and a UWB antenna arranged to cooperate with UWB anchors situated in the access points.

5. The mobile equipment according to claim 1, wherein connection quality is evaluated from a power level and/or from a binary data rate for each reference signal received by the communication device.

6. The mobile equipment according to claim 1, wherein the space to be mapped is partitioned into unit zones of the space, and wherein the control component is arranged to associate the current position and the connection quality as evaluated in the current position with a unit zone of the space in which the current position is situated.

7. The mobile equipment according to claim 6, wherein each unit zone of the space is a unit volume.

8. The mobile equipment according to claim 1, wherein the control component is arranged to control the power with which each access point transmits the reference signal.

9. The mobile equipment according to claim 1, wherein the control component is arranged to select a communication channel over which each access point transmits the reference signal.

10. The mobile equipment according to claim 1, wherein the control component is arranged to evaluate, for each access point, a strength for the signal transmitted by said access point and received by the communication device, and to cause each of the access points to transmit reference signals in succession in an order corresponding to decreasing signal strength.

11. The mobile equipment according to claim 1, wherein the control component is also arranged to interrogate each access point so that each access point sends to the mobile equipment a power level for the signal received by said access point.

12. The mobile equipment according to claim 1, wherein the control component is also arranged to interrogate each access point so that said access point sends to the mobile equipment functional characteristics of said access point.

13. The mobile equipment according to claim 1, the mobile equipment being a smartphone.

14. A mapping method for mapping a space to be mapped, the method comprising the steps of:
acquiring the current position of the mobile equipment according to any preceding claim;
controlling each access point selectively and in independent manner via the communication device so as to cause said access point to transmit a reference signal;
for each access point, evaluating a quality for the connection between said access point and the mobile equipment in the current position;
creating a current record containing the connection qualities associated with the current position;
storing the current record in a database.

15. The mapping method according to claim 14, wherein the space to be mapped is partitioned into a plurality of unit zones of the space, the mapping method further comprising the step of defining a current unit zone of the space in which the current position is situated, and of associating the current record with the current unit zone of the space.

16. The mapping method according to claim 14, wherein, for each access point, connection qualities are evaluated for a plurality of transmission configurations of said access point.

17. The mapping method according to claim 14, wherein the database also includes functional characteristics of the access points.

18. The mapping method according to claim 14, wherein the database also includes timestamped positioning data for the mobile equipment (10).

19. The mapping method according to claim 14, further comprising the step of producing a map showing the zones that have been covered and the zones that have not yet been covered by the method for mapping the space to be mapped.

20. A computer program including instructions for causing the mobile equipment according to claim 1 to execute the steps of a mapping method for mapping a space to be mapped, the method comprising the steps of:
acquiring the current position of the mobile equipment according to any preceding claim;
controlling each access point selectively and in independent manner via the communication device so as to cause said access point to transmit a reference signal;
for each access point, evaluating a quality for the connection between said access point and the mobile equipment in the current position;
creating a current record containing the connection qualities associated with the current position;
storing the current record in a database.

21. A computer-readable non-transatory storage medium storing the computer program according to claim 20.
